(19) United States
(12) Patent Application Publication
(10) Pub. No.: US 2006/0015401 A1
(43) Pub. Date: Jan. 19, 2006

(54) Efficiently spaced and used advertising in network-served multimedia documents

(76) Inventors: Barry Hsiao-tung Chu, Pasadena, CA (US); Sarah M. J. Mangold, Pasadena, CA (US); Jennifer E. Hampikian, Pasadena, CA (US); Andrew Scott Negrin, Altadena, CA (US); Paul D. Beck, West Hills, CA (US); Michael Bayle, San Francisco, CA (US); Tod Edward Kurt, Pasadena, CA (US)

Correspondence Address: JAMES D IVEY, 3025 TOTTERDELL STREET, OAKLAND, CA, 94611-1742, US

(21) Appl. No.: 10/893,761

(22) Filed: Jul. 15, 2004

(51) Int. Cl. G06Q 30/00

(52) U.S. Cl. 705/14

(57) ABSTRACT

A two-stage sponsored link mechanism is embedded in a Web page such that the amount of available information to the user is exponentially related to the space devoted to the sponsored links. In the first stage, a server provides categories and topics, in the form of searchable keywords, for inclusion in the Web page. In the second stage, the user clicks on one of the keywords under one of the categories to generate a search request for search listings associated with the keyword. The server returns a number of search listings selected according to the value attributed to each search listing by its owner. By providing multiple topics to the user, the likelihood the user will find information of interest, and thus access of such adjunct information, is significantly increased.

### FIELD OF THE INVENTION

This invention relates to the field of electronic document publication systems, and more specifically to a system for combining searchable information into an electronic document such as a web page.

### BACKGROUND

The Internet is a wide area network having a truly global reach, interconnecting computers all over the world. That portion of the Internet generally known as the World Wide Web is a collection of inter-related data whose magnitude is truly staggering. The content of the World Wide Web (sometimes referred to as “the Web”) includes, among other things, documents of the known HTML (Hyper-Text Mark-up Language) format which are transported through the Internet according to the known protocol, HTTP (Hyper-Text Transport Protocol).

In addition to the wealth of information found in such HTML documents, the Web can include content which is interactive, i.e., which is responsive to data specified by a human user of a computer connected to the Web, through the known Common Gateway Interface (CGI). The Web can include active content as well, namely, applets in the form of executable computer instructions which are delivered through the Internet to execute on the recipient computer. Such content, whether documents, interactive, and/or active, represents a wealth of informational services available through the Internet.

While many are fond of saying that the information services available are free, such services are not free in reality. Connection to the Internet requires access to network connectivity. Clients, i.e., users hoping to access such information services, must generally pay subscription fees for access to Internet connectivity and must buy a computer and connection hardware such as a modem. Servers, i.e., computer systems which provide such information services, are high-performance computers and are typically coupled to the Internet through highly available, highly reliable, and high-bandwidth communications media such as dedicated T1 and T3 lines. Thus, the hardware and the connectivity can be reasonably expensive. In addition, the information services provided by a server can be quite complex and require customized development and implementation at considerable expense.

These expenses are compensated in a number of ways. For the clients, the expense of Internet access is compensated by the perceived value of the information available therethrough. For the servers, the expense of providing such information services is compensated by the perceived value of having the information available to the clients. On the server side, this perceived value can be somewhat distributed. In particular, an Internet-based reseller perceives value in advertising goods and services to potential purchasers. This perceived value can be distributed to other servers by having the other servers display advertisements along with their information which is otherwise sought out by clients who can be potential purchasers. For example, a patent attorney hoping to attract paying clients can pay an intellectual property law portal information service on the Internet to display an advertisement of the patent attorney's services.

This phenomenon of offering advertising space on Web pages has led to a proliferation of banner ads, namely, wide graphical advertisements of products and services available elsewhere on the Internet. To maximize returns from displaying banner ads in conjunction with information services, many web pages contain multiple banner ads which can consume significant display area and can add so much clutter around the information sought by the clients as to obscure the value and impact of such information. However, beyond the visual clutter caused by multiple banner ads is the opportunity cost in terms of other advertisements which could have been included and which might have caught the interest of more clients, i.e., which might have generated additional income. In short, banner ads tend to crowd one another out and diminish the effectiveness of one another, to the detriment of both the server hoping to generate revenue from such banner ads and the sponsors of the banner ads themselves.

Another disadvantage of banner ads is that the value diminishes with repeated impressions, i.e., instances of display. Clients who are interested in the advertised information tend to click on the banner ad after just a few impressions, and multiple impressions to clients not interested in the advertised information is wasted effort. However, changing of banner ads typically includes changing of the Web page itself manually to include different banner ads and/or inclusion of fairly complicated logic within the Web page itself to change the banner ads automatically.

The inefficiency of display of banner ads and the difficulty in changing such banner ads result in less than optimal return for presenting information services of significant interest to clients throughout the Internet.

### SUMMARY OF THE INVENTION

In accordance with the present invention, a two-stage sponsored link mechanism is embedded in a Web page such that the amount of available information to the user is exponentially related to the space devoted to the sponsored links. In the first stage, a sponsored link server receives a request for categories and topics, in the form of searchable keywords, for inclusion in the Web page. The request can be received from a host computer system serving the Web page or a client computer system which has received the Web page from the host computer system.

The sponsored link server selects a few categories from a collection of many categories according to the substantive content of the Web page, such that only relevant categories are included. The substantive content of the Web page is analyzed to identify a number of keywords included in the substantive content of the Web page. Categories are selected according to the number of appearances in the substantive content of the Web page of instances of keywords of the categories. Categories can also be selected according to respectively measured relative performance of the categories.

In sending data representing the few categories in response to the request, a number of keywords representing topics of each of the categories are included as well. The keywords are placed in the context of respective links, each of which specifies a search of sponsored listings associated with the corresponding keyword. Thus, in a space slightly greater than that of a typical banner ad, the use is presented with a few categories and a number of topics under each of those categories. Already, the amount of adjunct information available to the user is far more efficiently presented than can be presented in a banner ad. Such increases the likelihood that the user will be interested in some of adjunct information and will request some of that adjunct information. Accordingly, such increases the likely return generated by providing access to the adjunct information.

In selecting the keywords to include with each category, keywords are selected randomly such that each keyword is likely to be included in a number of link spaces over many instances of serving link spaces. In addition, the randomized selection is influenced by relative measured performance of each of the keywords such that better performing keywords are served more frequently to thereby further improve the return generated by making adjunct information available to the user.

In the second stage, the user clicks on one of the keywords under one of the categories. This clicking results in a URL being received by the sponsored link server as a search request for search listings associated with the keyword. The sponsored link server returns a number of search listings selected according to the value attributed to each search listing by its owner. Accordingly, return from making adjunct information to the user is improved even further.

By allowing the user to select the most interesting of a number of topics of a number of categories and then presenting the most highly valued adjunct information in response to that selection, the return generated from making adjunct information available is greatly improved over return generated by other mechanisms.

### BRIEF DESCRIPTION OF THE DRAWINGS

FIG. 1 is a block diagram showing a sponsored link server, host computer systems, and client computer systems coupled to one another through a wide area network.

FIGS. 2 and 3 are Web page displays incorporating adjunct information from the sponsored link server of FIG. 1 according to the present invention.

FIG. 4 is a transaction flow diagram illustrating the incorporation of adjunct information into a Web page in accordance with the present invention.

FIG. 5 is a block diagram of the sponsored link database of FIG. 4 in greater detail.

FIGS. 6-9 are block diagrams of the various components of the sponsored link database of FIG. 5 in greater detail.

FIG. 10 is a logic flow diagram of the selection of a composite category by the sponsored link server in accordance with the present invention.

FIG. 11 is a logic flow diagram of the selection of a number of keywords for each constituent category of the composite category by the sponsored link server in accordance with the present invention.

FIG. 12 is a transaction flow diagram illustrating the incorporation of adjunct information into a Web page in accordance with an alternative embodiment of the present invention.

### DETAILED DESCRIPTION

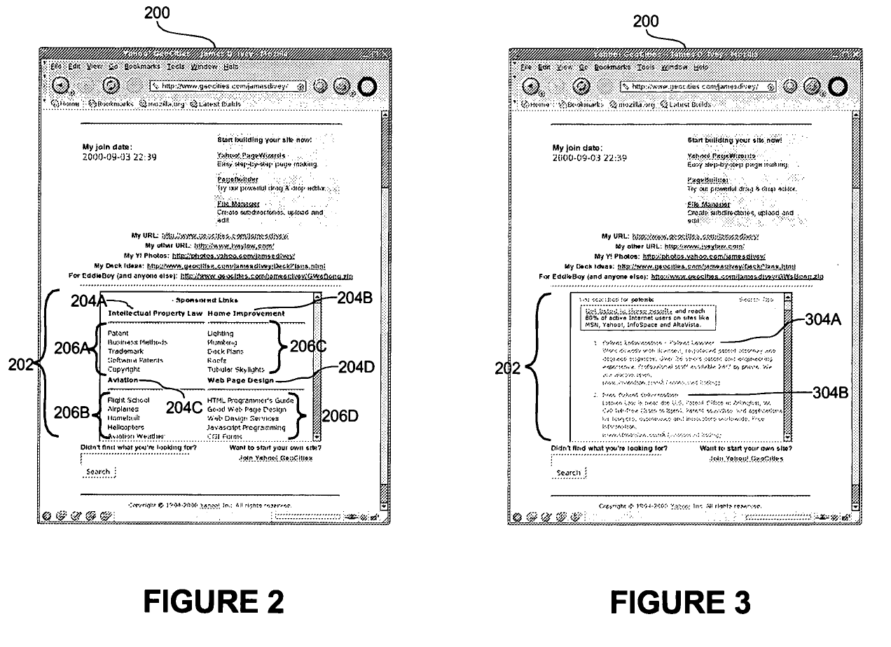

In accordance with the present invention, a two-stage sponsored link mechanism is integrated into a link space 202 (FIG. 2) of a Web page 200. In the first stage, a sponsored link server provides one or more categories 204A-D of adjunct information, each of which includes a respective one of keyword sets 206A-D. Each keyword set includes a number keyword associated with the respective category. In this illustrative example, four (4) categories 204A-D, each of which is associated with a keyword set 206A-D which in turn includes five (5) keywords. Accordingly, in a space not much bigger than a banner ad, Web page 200 includes twenty (20) keywords, each of which can be associated with numerous links to adjunct information which can be of interest to the user viewing link space 202.

In the second stage, the user clicks on one of the keywords displayed in sponsored links space 202. The sponsored link server responds with the click with a list of a number of sponsored listings 302A-B (FIG. 3) which then fill link space 202. Sponsored links 302A-B are sponsored in that, if the client clicks on any of sponsored links 302A-B, the owner of the clicked sponsored link compensates the owner of Web page 200 for providing the client access to the sponsored link. Each of sponsored links 302A-B references adjunct information to Web page 200. Such adjunct information in this illustrative embodiment is related to the substantive content of Web page 200 and is presented to the user viewing Web page 200 only in response to a request by the user so requesting.

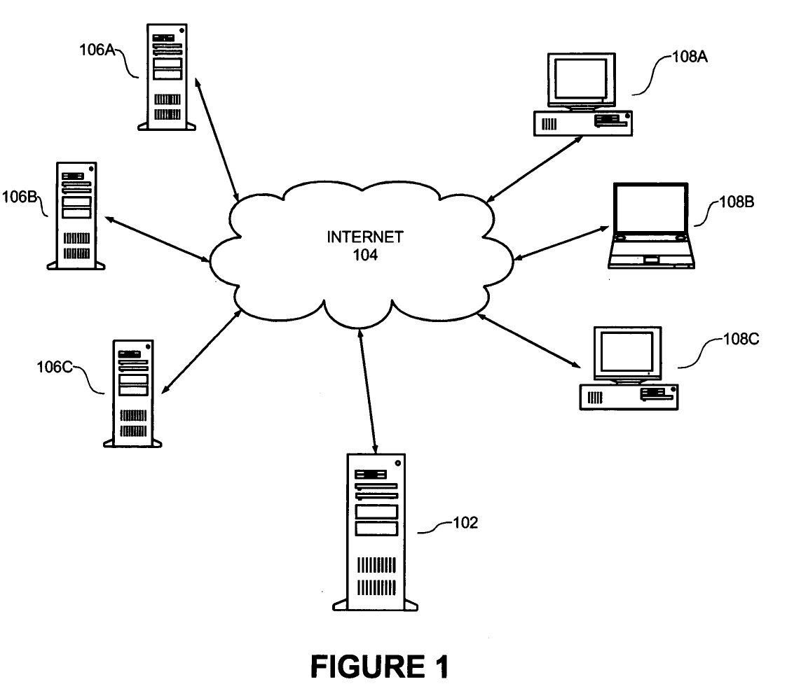

Greatly simplified for illustration purposes, FIG. 1 shows a sponsored link server 102 which is coupled to, and serves, a wide area network 104 which is the Internet in this illustrative embodiment. A number of host computer systems 106A-C are coupled to Internet 104 and host and provide content to a number of client computer systems 108A-C. While only three (3) host computer systems and three (3) client computer systems are shown, it should be appreciated that (i) host computer systems and client computer systems coupled to the Internet collectively number in the millions of computer systems and (ii) host computer systems can retrieve information like a client computer system and client computer systems can host and provide information like a host computer system.

In this illustrative example, sponsored link server 102 is a computer system which provides a search service. In providing the search service, sponsored link server 102 catalogs information hosted by host computer systems 106A-C and serves search requests of client computer systems 108A-C for information which may be hosted by any of host computers 106A-C. The cataloged information is organized according to keywords, which include phrases as well as individual words and each of which can be used as a search term. Each unit of information which can be returned to any of client computer systems 108A-C is sometimes referred to as a search listing. Each search listing associates a keyword with a title, a description, a link, and a value attributed by the owner of the search listing.

In response to such requests, sponsored link server 102 produces a result set of any search listings which matches one or more search terms specified in the search request. The respective links of such search listings refer to Web sites hosted by host computer systems 106A-C. Information contained within such Web sites can be retrieved through the known and widely used hypertext transport protocol (HTTP) in a portion of the Internet widely known as the World Wide Web. A single multimedia document presented to a user is generally referred to as a Web page and inter-related web pages under the control of a single person, group, or organization is generally referred to as a Web site.

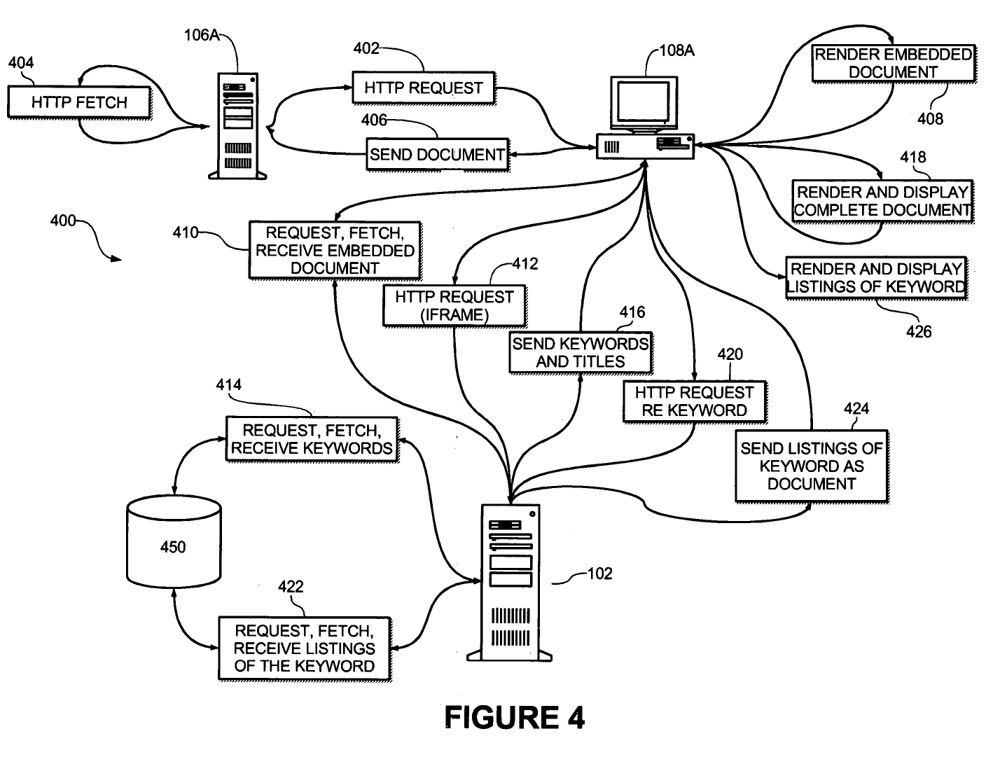

The formation and management of link space 202 (FIGS. 2 and 3) is illustrated in transactional flow diagram 400 (FIG. 4). Transactional flow diagram 400 illustrates the viewing on client computer system 108A of a Web page hosted by host computer system 106A wherein the Web page includes sponsored links provided by sponsored link server 102.

In step 402, client computer system 108A requests Web page 200 (FIG. 2) by sending an HTTP request which includes a Universal Resource Locater (URL) of Web page 200. In response to the HTTP request, host computer system 106A fetches Web page 200 from storage within host computer system 106A in step 404 and sends Web page 200 to client computer system 108A in step 406.

As stored within host computer 108A and sent to client computer system 106A, Web page 200 includes an embedded tag specifying a place for link space 202 (FIG. 2) within Web page 200. Tags are known components of HTML and are not described herein. In this illustrative embodiment, the embedded tag specifies a JavaScript component and is of the following form:

<script language=“JavaScript”>
<!--
ctxt_ad_interface=‘ . . . ’;
ctxt_ad_width=420;
ctxt_ad_height=280;
ctxt_ad_partner=‘partner-id’;
ctxt_ad_frameborder=‘0’;
ctxt_ad_id=‘1’;
// -->
</script>
<script language=“JavaScript”
src=“http://www.cmhtml.overture.com/partner/jd/linkspots.js”>
</script>

The parameters of the above JavaScript tag are described in the following Table.

TABLE A

| Parameter | Description |
|---|---|
| ctxt_ad_interface | Specifies a component within sponsored link |
| | server 102 that performs database access to |
| | collect categories, keywords, and search listings |
| | in the manner described below and that formats |
| | the categories, keywords, and/or search listings |
| | as a response to the embedded tag. |
| ctxt_ad_width | Specifies the width of link space 202 (FIGS. 2 |
| | and 3) and, in this illustrative embodiment, must |
| | be one of a number of accepted widths defined by |
| | sponsored link server 102. |
| ctxt_ad_height | Specifies the height of link space 202 and, in this |
| | illustrative embodiment, must be one of a number |
| | of accepted heights defined by sponsored link |
| | server 102. |
| ctxt_ad_partner | Identifies the owner of Web page 200 as the party |
| | to be compensated if the user of client computer |
| | system 108A clicks on a sponsored link. |
| ctxt_ad_id | Identifies the categories and keywords which can |
| | be included in link space 202. |
| ctxt_ad_frameborder | Specifies the width in pixels of a border to be |
| | placed around link space 202. |

In step 408 (FIG. 4), client computer system 108A renders Web page 200 for display to the user. Such rendering is performed by a conventional web browser such as any of the widely known and used web browsers available from Netscape, Mozilla, Opera, and Microsoft. In rendering Web page 200, client computer system 108A parses all tags and determines which of the tags specify additional resources required to properly display Web page 200. Such resources can include images, video, audio, scripts, and applets, for example. Client computer system 108A sends HTTP requests for any such resources. Such parsing and requesting of requisite resources is conventional.

Included in the tags of Web page 200 is the embedded tag described above. In the parsing of tags and requesting of resources, client computer system 108A sends an HTTP request to sponsored link server 102 according to the “src” component of the above-described embedded tag. This request is represented as step 410 (FIG. 4), and in the transaction of step 410, sponsored link server 102 fetches and returns a JavaScript component which controls the behavior of Web page 200 within link space 202.

Upon receipt of the JavaScript component, client computer system 108A executes the JavaScript component, execution of which causes client computer system 108A to send another HTTP request to sponsored link server 102 in step 412. This HTTP request causes sponsored link server 102 to return categories and keywords in the first stage of the sponsored link management system according to the present invention.

Processing by sponsored link server 102 in response to the HTTP request of step 412 is described more completely below. Briefly, sponsored link server 102 requests, fetches and receives a number of keywords and categories from a search listing database 450 and sends those keywords and categories to client computer system 108A.

Upon receipt of the keywords and categories, execution of the JavaScript component integrates the received keywords and categories into Web page 200 for an integrated display in step 418. The resulting display of Web page 200 is shown in FIG. 2.

Link space 202 includes four (4) categories 204A-D with the respective titles “Intellectual Property Law,” “Home Improvement,” “Aviation,” and “Web Page Design” displayed. Under each category, link space 202 includes a respective one of keyword sets 206A-D, each of which in turn includes five (5) keyword links. Each keyword link includes a link tag which specifies sponsored link server 102 as the computer system to process any HTTP requests resulting from activation of the link. In other words, sponsored link server 102 is specified by the respective URL associated with each of the keyword links.

To initiate the second phase of the sponsored link management system in this illustrative embodiment, the user of client computer system 108A clicks on the first link of keyword set 206A which is associated with the keyword, “patent”, under category 204A, “Intellectual Property Law.” The URL of the tag identifying the target of the keyword link specifies sponsored link server 102 as the computer system to which the HTTP request is directed and identifies “patent” as the keyword in which the user is interested, sometimes referred to as the “subject keyword”. In addition, the link identifies the owner of Web page 200 as the party to be compensated for user requests of any sponsored links of link space 202. The HTTP request is sent from client computer system 108A to sponsored link server 102 in step 420 (FIG. 4).

Upon receipt of the HTTP request of step 420, sponsored link server 102 requests, fetches, and receives a number of search listings associated with the subject keyword from search listing database 450. In this illustrative embodiment, sponsored link server 102 retrieves those search listings associated with the subject keyword having the highest attributed values as specified by the respective owners of the search listings.

Sponsored link server 102 formats the retrieved search listings for display by, and sends them to, client computer system 108A in step 424. In this illustrative embodiment, sponsored link server 102 formats the retrieved search listings as an HTML document which can be displayed within an iframe. Iframes are known components of HTML documents and are not described herein.

In step 426, client computer system 108A receives the search listings in the form of the HTML document representing the content of the iframe of link space 202 and displays the HTML document to display sponsored links 302A-B (FIG. 3) to the user. Clicking on a sponsored link, e.g., sponsored link 302A, is processed in a conventional manner by (i) retrieving and displaying a Web page associated with sponsored link 302A and (ii) noting that sponsored link 302A was clicked from within Web page 200 such that proper compensation can be made (a) from the owner of sponsored link 302A to the owner of sponsored link server 102 and (b) from the owner of sponsored link 302A and/or the owner of sponsored link server 102 to the owner of Web page 200.

A few advantages are achieved in the sponsored link management system described. First, the sponsored link management system described above is very easy to include into a Web page such as Web page 200. All that is required is that the embedded JavaScript tag described above be included in Web page 200 as served by host computer system 106A. Second, a relatively large number of sponsored links can be presented to the user in the relative compact space of link space 202. As described more completely below, sponsored link server 102 retrieves keywords within various categories in a dynamic, changing manner such that a large number of keywords within a given category are each delivered with some regularity over a large number of impressions of a link space. In short, sponsored link server 102 rotates served keywords in a somewhat randomized manner to ensure that no keyword is under- or over-represented in link spaces collectively. This rotation of keywords can be relatively complex, but the author of Web page 200 can ignore that complexity altogether as sponsored link server 102 maintains responsibility for such rotation of keywords.

Another advantage realized in the sponsored link management system described herein is that each of the keywords displayed in link space 202 (FIG. 2) is associated with a large number of search listings as shown in FIG. 3. In one embodiment, the number of search listings served by sponsored link server 102 (FIG. 4) in step 424 is limited to a predetermined maximum, e.g., five (5), with another link to view search listings beyond that predetermined maximum. Thus, in a space which is marginally larger than a typical banner ad, twenty (20) keywords can be displayed and associated with five (5) sponsored links each—providing the view of Web page 200 with immediate access to one hundred (100) sponsored links with just two mouse clicks, with hundreds or thousands of sponsored links reachable by just one more mouse click.

The rotation of keywords and the ranking of search listings associated with a keyword by value attributed to the search listings provides a highly maximized return for the amount of display space devoted to sponsored links by Web page 200.

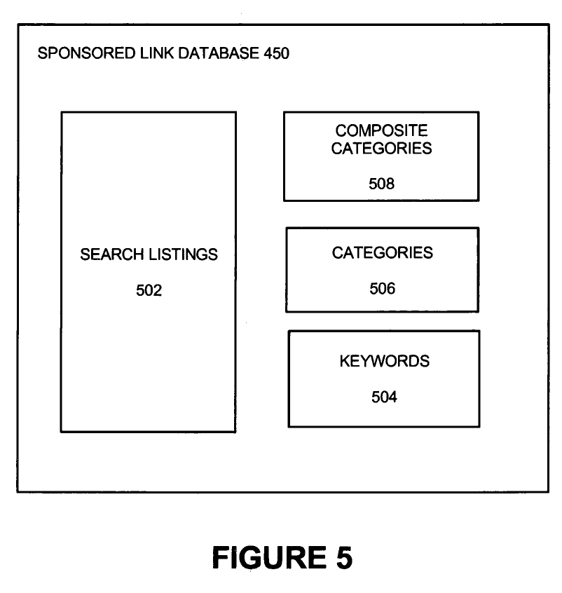

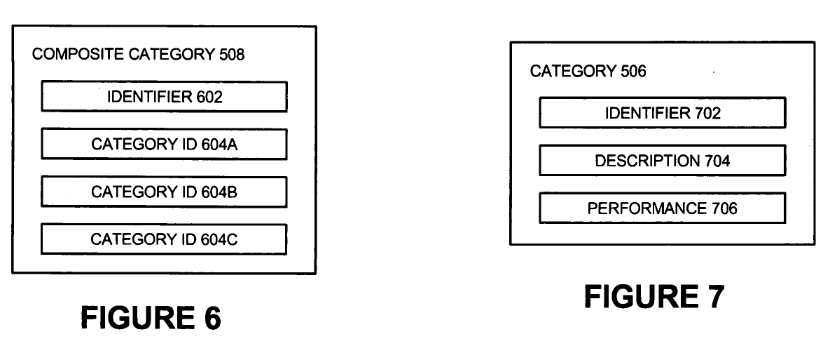

Sponsored link database 450 is shown in greater detail in FIG. 5. Sponsored link database 450 includes search listings 502, keyword records 504, category records 506, and composite categories 508. An example of composite categories 508 is shown in FIG. 6.

Composite category 508 (FIG. 6) represents a collection of one or more categories of keywords to be presented in a single link space such as link space 202 (FIG. 2). Composite category 508 (FIG. 6) includes an identifier 602 and one or more category fields 604A-C. Identifier 602 includes data which identifies composite category 508 uniquely with respect to all other composite categories represented within sponsored link database 450. Category fields 604A-C identify keyword categories which are included in the one or more categories of composite category 508. While three category fields 604A-C are shown to be included in composite category 508, it should be appreciated that more or fewer categories can be included. Each of category fields 604A-C identifies one of category records 506 (FIG. 5), an example of which is shown in FIG. 7.

Category record 506 represents a single category of keywords and includes an identifier 702 and a description 704. Identifier 702 includes data which identifies category 506 uniquely with respect to all other category records represented within sponsored link database 450. Description 704 provides a textual description of category which can be used to form the textual descriptions of categories 204A-D (FIG. 2). In this illustrative embodiment, membership of a keyword in a particular category is specified in the keyword record itself rather than within category record 506 (FIG. 7). However, it should be appreciated that such membership can be alternatively or additionally specified within category record 506 as a list of member keyword records, for example.

Category record 506 includes a performance field 706 which specifies aggregate performance of the keywords of the category of category record 506. Such performance is measured, in this illustrative embodiment, as an expected return from display of the keywords of the category in a link space such as link space 202 (FIG. 2). Both the popularity of the category with clients and the value attributed to the keywords of the category by owners of search listings associated with the keywords influence overall performance of a given category. Such performance estimation is determined in a manner described more completely below.

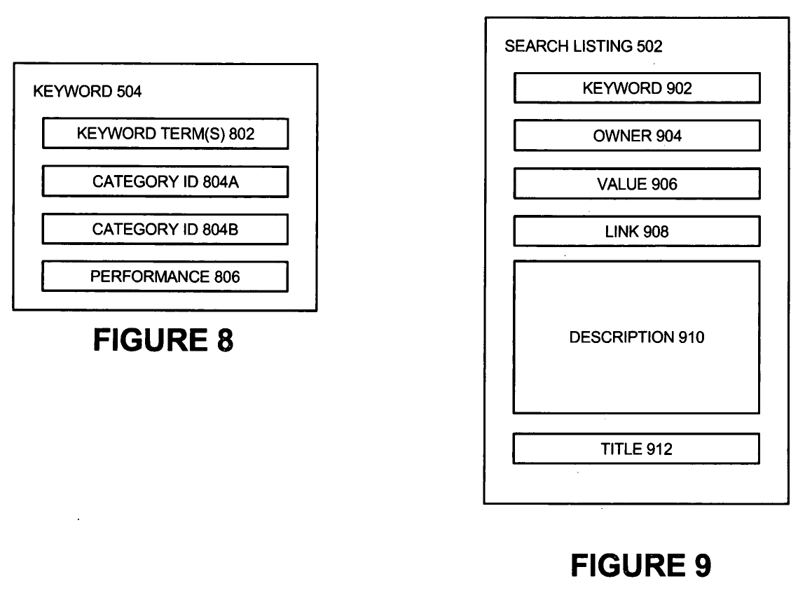

Keyword records 504 (FIG. 5) represent keywords and keyword phrases with which search listings 502 are associated. An example of keyword records 504 is shown in FIG. 8.

Keyword record 504 includes one or more keyword terms 802. Examples are shown in keyword sets 206A-D (FIG. 2). In this illustrative embodiment, keyword terms 802 (FIG. 8) acts as a unique identifier of keyword record 504, unique relative to all other keyword records stored in sponsored link database 450. In an alternative embodiment, a separate identifier is included within keyword record 504 to uniquely identify keyword record 504.

Keyword record 504 includes one or more category identifiers 804A-B to specify one or more respective categories of which keyword record 504 is a member. Category identifiers 804A-B correspond to identifiers 702 (FIG. 7) of respective categories of which keyword record 504 is a member. In this illustrative embodiment, keyword record 504 can be a member of multiple categories, limited only by the number of categories represented in sponsored link database 450. In an alternative embodiment, each keyword record 504 can be a member in only one category.

Keyword record 504 includes a performance field 806 which specifies performance of the keyword represented by keyword record 504. Such performance is measured, in this illustrative embodiment, as an expected return from display of the keyword in a link space such as link space 202 (FIG. 2). Both the popularity of the keyword with clients and the value attributed to the keyword by owners of search listings associated with the keyword influence overall performance of a given keyword. Such performance estimation is determined in a manner described more completely below.

Search listings 502 (FIG. 5) represent information available elsewhere through Internet 104, e.g., through any of server computer systems 106A-C. Providing such information is a primary function of sponsored link server 102. Each of sponsored links 302A-B (FIG. 3) is represented by a respective one of search listings 502 (FIG. 5), an example of which is shown in greater detail in FIG. 9.

Search listing 502 includes a keyword field 902, an owner field 94, a value field 906, a link field 908, and a description field 910. It should be appreciated, that additional fields can be included in search listing 502 and other records stored in sponsored link database 450 to provide functionality beyond that described herein. However, description herein is limited to a relatively few fields which facilitate appreciation and understanding of sponsored link management in accordance with the present invention.

Keyword field 902 identifies the keyword to which search listing 502 pertains by identifying a selected one of keyword records 504 (FIG. 5). Owner field 904 identifies the owner of search listing 502. Value field 906 specifies the value of search listing 502 as attributed by the owner. In this illustrative embodiment, the owner of search listing 502 agrees to compensate the owner of sponsored link server 102 in the amount specified in value field 906 each time a user of a client computer system requests access to information through search listing 502. Thus, the owner of search listing 502 is the entity valuing display of certain information to people and the precise value attributed to such display is represented in value field 906.

Link field 908 represents an address through Internet 104 at which the information associated with search listing 502 is reachable. In this illustrative embodiment, link field 908 stores a URL of that information. Description field 910 describes that information to inform the user of a client computer system regarding the information available through link field 908 such that the user can make an informed decision as to whether to view that information. Title field 912 provides a succinct description of the information in a form suitable as a one-line title for the information.

In the embodiment shown in FIG. 3, the title, description, and link address of sponsored links 302A-B are shown in link space 202.

As described above, performance of a keyword is estimated as an expected return from display of the keyword in a link space such as link space 202 (FIG. 2). In one embodiment, the performance of a keyword is estimated as follows. Each position of a sponsored link, e.g., sponsored links 304A-B ((3), has an expected click-through rate which is determined in a manner described in co-pending and commonly-owned U.S. patent application Ser. No. 10/429,208 (“Content Performance Assessment Optimization for Search Listings in Wide Area Network Searches” by Dominic Cheung et al.—hereinafter the '208 application) and that description is incorporated herein by reference. In addition, each search listing has an absolute click-through rate determined in a manner described in the '208 application and that description is also incorporated herein by reference.

In determining a value to store as performance field 806 ((8) to represent the expected performance of the subject keyword, sponsored link server 102 determines which of search listings 502 ((5) are to be included in link space 202 ((2) in what respective positions. Sponsored link server 102 weights the respective values of the search listings according to value field 906 and according to the expected click-through rates of the respective positions to form a weighted average return for keyword. That weighted average is stored in performance field 806 ((8) to represent the expected return of the keyword. In an alternative embodiment, sponsored link server 102 weights the respective values of the search listings by their absolute click-through rates to determine a weighted average which is stored in performance field 806 ((8) to represent the expected return of the keyword.

As described above, the performance of a category is estimated as an expected return from display of the keywords of the category in a link space such as link space 202 (FIG. 2). In this illustrative embodiment, such performance is estimated by determining the average performance of all keywords within the category.

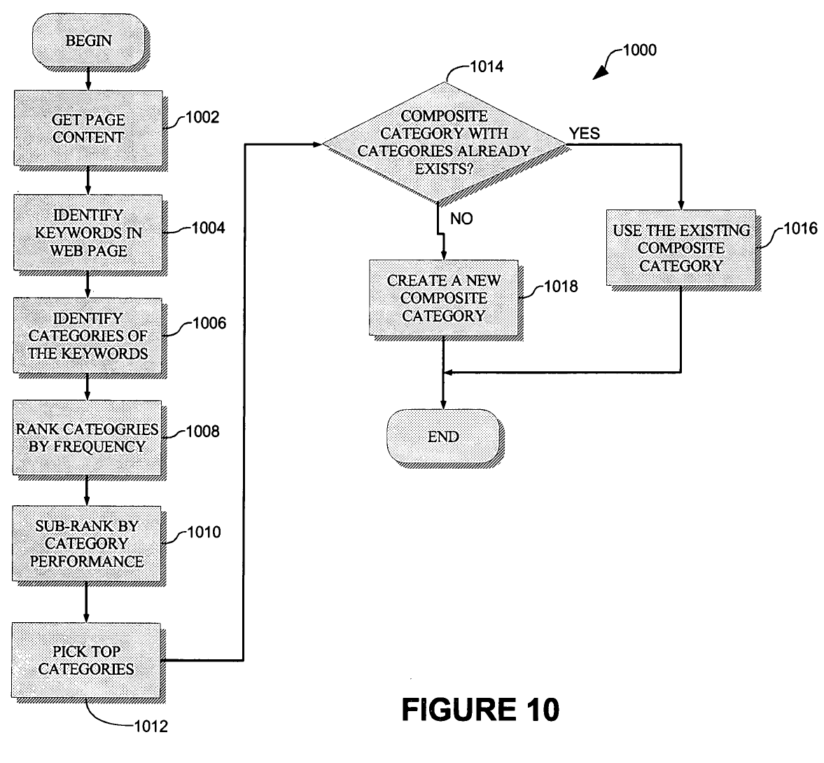

One of the major components of maximizing return of a link space such as link space 202 is the selection of categories to include in a composite category—in particular, the matching of keyword categories to the substantive content of the Web page within which the link space is included. In this illustrative embodiment, selection of a composite category for a given Web page is done once and is reused for each display of a link space. The composite category for a Web page can be adjusted if the content of the Web page changes substantially or if estimated performance of one or more categories changes substantially. The selection of a composite category for a subject Web page by sponsored link server 102 is illustrated by logic flow diagram 1000 (FIG. 10).

In step 1002, sponsored link server 102 retrieves the content of the subject Web page. In step 1004, sponsored link server 102 identifies keywords and keyword phrases in the subject Web page, noting the frequency of appearance of the respective keywords and keyword phrases. In step 1006, sponsored link server 102 identifies the categories of the keywords found in the subject Web page. The sum of all appearances of keywords of a given category represents a degree of representation of the category within the Web page. The matching of keywords within a Web page can be done using the ubiquitous grep program available in Unix, Linux, and many similar operating systems, e.g., after removing any tags and/or non-visible text from the Web page content using conventional parsing techniques. A more elaborate mechanism for recognizing keywords within a web page is described more completely below.

To select the most appropriate categories for the subject Web page, sponsored link server 102 ranks the categories whose keywords appear in the subject Web page according the degree of representation of the categories in the Web page in step 1008. To maximize return of link space 202 in step 1010, sponsored link server 102 adjusts the rankings according to performance of the respective represented categories of the Web page using performance fields such as performance field 706 (FIG. 7) of category record 506. Thus, between two categories which relatively equal representation within the subject Web page, the category with better overall performance is preferred.

In step 1012, sponsored link server 102 selects the top-ranked categories to produce a composite category for the subject Web page. In test step 1014, sponsored link server 102 determines whether a composite category with the same constituent categories already exists in sponsored link database 450. If one does exist, sponsored link server 102 associates that pre-existing composite category with the subject Web page in step 1016. Conversely, if no such composite category exists, sponsored link server 102 creates a new composite category and associates the newly created composite category with the subject Web page in step 1018.

In general, there are many more keywords associated with a given category than can be displayed in link space 202 (FIG. 2). In this illustrative embodiment, five (5) keywords are displayed for each category. It is preferred that, within the multitude of link spaces served by sponsored link server 102 taken collectively, all keywords of a given category appear with some frequency. Accordingly, sponsored list server 102 randomizes the selection process by which individual keywords are selected for each category in a link space. In one embodiment, sponsored link server 102 selects the keywords randomly. Over many requests for keywords over time, e.g., from many client computer systems attached to Internet 104 making such requests periodically, all keywords would have generally the same rate of appearance. In an alternative embodiment, the random selection process is weighted according to performance of each keyword, e.g., as represented in performance field 806 ((8). Since some keywords generate more return value for inclusion in a link space, using those keywords more frequently improves the overall return generated by a link space.

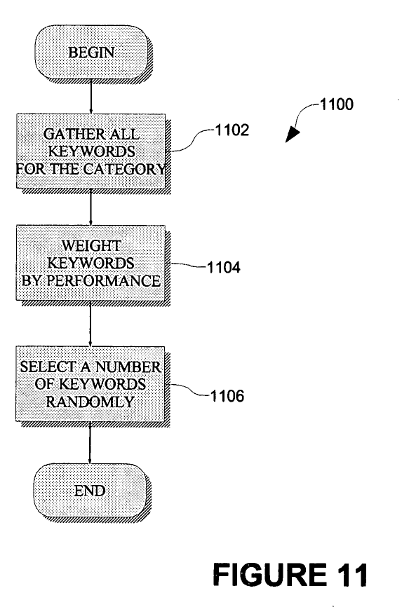

Logic flow diagram 1100 (FIG. 11) illustrates such a weighted selection process by sponsored link server 102. In step 1102, sponsored link server 102 gathers all keywords of a given category and the associated respective performance measurements of the keywords, e.g., as represented in performance field 806 (FIG. 8). In step 1104, sponsored link server 102 weights the likelihood of selection of each keyword by its associated relative performance. Steps 1102-1104 can be performed just once for a large number of keyword selections since the relative performance of individual keywords is not expected to change frequently. In one embodiment, performance of each keyword is updated on a daily basis. In this embodiment, performance of steps 1102-1104 can be performed only once daily.

In step 1106, sponsored link server 102 randomly selects a number, e.g., five (5), of the keywords gathered in step 1102 wherein the random selection is performed in accordance with the weighted likelihoods of selection. Thus, by selecting keywords of a category according to measured performance, sponsored link server 102 further increases the return generated by link space 202 (FIGS. 2 and 3).

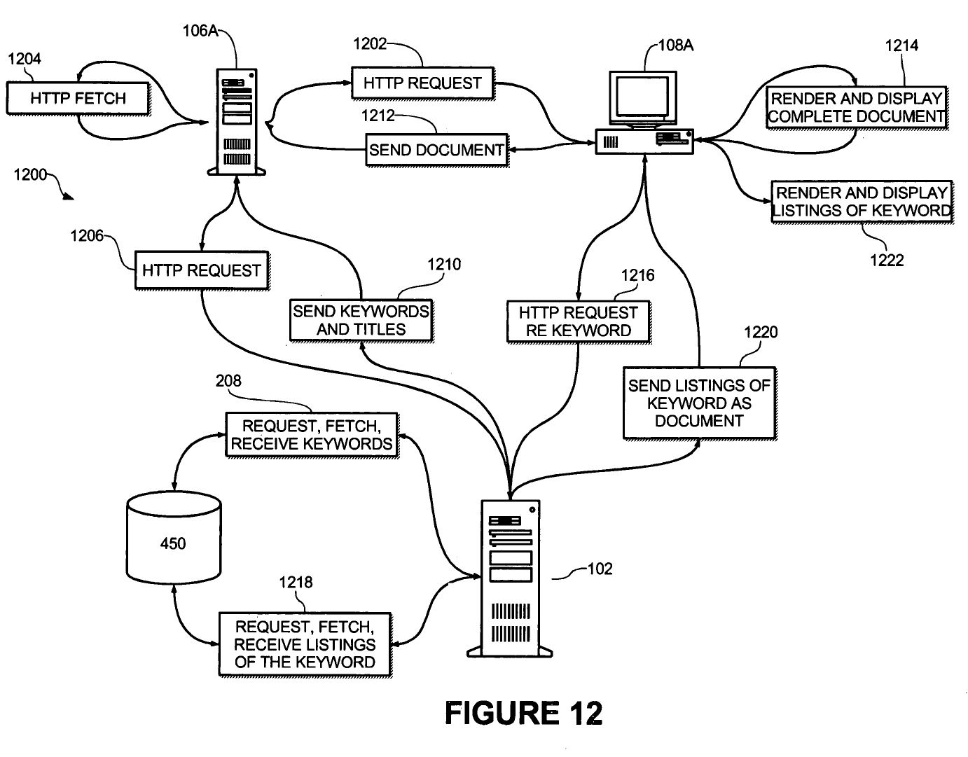

Transaction flow diagram 1200 (FIG. 12) illustrates an alternative embodiment to the embodiment described above with respect to FIG. 4. The transaction begins in with an HTTP request in step 1202 which is directly analogous to the HTTP request of step 402 described above. In step 1204, host computer system 106A fetches the requested HTML document. In this alternative embodiment, the HTML document specifies link space 202 (FIG. 2) using embedded tags, such as XML tags, rather than a JavaScript tag. The embedded XML tag is generally of the format described above with respect to Table A and includes generally the same information. The primary difference is that host computer 106A resolves the embedded XML tags to retrieve the categories and keywords in transaction flow diagram 1200 (FIG. 12) while client computer system 108A executes the embedded JavaScript tag to retrieve the categories and keywords in transaction flow diagram 400 (FIG. 4). Specifically, in step 1206 (FIG. 12), host computer system 106A sends an HTTP request to sponsored link server 102, and the HTTP request specifies a composite category.

In response to the HTTP request in step 1208, sponsored link server 102 requests, fetches, and receives categories and keywords from sponsored link database 450 in the manner described above with respect to step 415. Sponsored link server 102 sends the categories and keywords to host computer 106A in step 1210. One of the advantages of the embodiment shown in FIG. 12 is that host computer 106A can store the returned categories and keywords in a cache after step 1210 and omit steps 1206-1210 for future HTTP request for the same Web page. Accordingly, less network traffic is generated using the embodiment of FIG. 12. Host computer 106A can set the categories and keywords stored in cache to expire periodically to allow the keywords to rotate in the manner described above.

Once host computer system 106A has received the categories and keywords from sponsored link server 102, host computer system 106A incorporates the categories and keywords into Web page 200 such that Web page 200 defines the view seen in FIG. 2. Client computer system 108A and sponsored link server 102 cooperate in the manner described above to enable the user of client computer system 108A to browse information related to the categories and keywords shown in link space 202. In particular, steps 1214-1222 are directly analogous to steps 418-426, respectively, as described above.

Thus, return for space devoted to sponsored links is maximized using a number of techniques, including (i) division of the space into multiple categories with multiple keywords to allow the user to select a category and keyword of most interest, (ii) choosing the categories according to the content of the Web page in which the space resides to maximize likelihood of interest of the user in a displayed category and keyword, (iii) choosing the categories according to performance of the respective categories to display categories of most interest to users generally, (iv) choosing keywords within each categories according to performance of the respective keywords to display keywords of most interest to users generally, (v) rotating the selected keywords across multiple displays of a given categories to maximize the number of keywords displayed to users, and (vi) displaying search listings associated with a given keyword according to value attributed to the search listings by their respective owners.

As described above with respect to step 1004 ((10), sponsored link server 102 identifies a number of keywords related to the substantive content of a subject Web page. To start, a number of Web pages from the Web site containing the subject Web page are analyzed. Sponsored link server 102 can identify additional Web pages of the Web site by following links of the subject Web page, where the links share a common URL root with the URL of the subject Web page.

Analyzing the Web pages of the Web site, sponsored link server 102 identifies a number of stop-words. Stop-words are words that appear frequently within a Web site but which do not generally reflect the content of any given page. An example is a name of a company or entity that owns and/or has authored the Web site; the name may appear frequently in the Web site but may not reflect the nature of the content of any of the Web pages of the Web site. Stop-words are identified using word frequency analysis that is weighted to reflect the respective positions of words within the Web page. Sponsored link server 102 calculates average frequency scores of the words of all analyzed Web pages of the Web site and normalizes the average frequency scores to differentiate appropriate stop-words.

Once stop-words are identified, sponsored link server 102 employs a weighted frequency analysis of the non-stop-words of the subject Web page to identify ten (10) individual words most likely to reflect the substantive content of the subject Web page. The weighting is selected such that words appearing earlier in the subject Web page are weighted more heavily than words appearing later in the subject Web page. Thus, words appearing more frequently and nearer the top of the subject Web page are presumed to be most indicative of the substantive content of the subject Web page. These ten (10) words are sometimes referred to herein as the top-ten words of the subject Web page.

Sponsored link server 102 analyzes the subject Web page to identify all two- and three-word phrases of the subject Web page which includes at least one of the previously determined top-ten words of the subject Web page. The two- and three-word phrases are added to the list of top-ten words of the subject Web page to define a list of candidate keywords. Sponsored link server 102 sorts the keywords of the list of candidate keywords according to frequency of appearance in the subject Web page and selects the more frequent keyword as the seed word.

Sponsored link server 102 combines the seed word with the other candidate keywords for match analysis relative to all keywords of sponsored link database 450 ((5). Such keywords are collectively represented in keyword field 902 ((9) of all search listings 502 ((5). Such match analysis includes greedy string-tiling analysis in this illustrative embodiment or hill-climbing string-tiling analysis in an alternative embodiment. Thus, sponsored link server 102 matches keywords of sponsored link database 450 to keyword candidates parsed from the subject Web page to determine the most likely of all keywords of sponsored link database 450 to be relevant to the subject Web page.

To select the most likely relevant categories to the subject Web page, sponsored link server 102 determines to which categories the matching keywords of sponsored link database 450 belong. Those categories with the greatest number of matching keywords are selected as the categories most relevant to the subject Web page. If two or more categories are relatively equally relevant to the subject Web page, sponsored link server 102 prefers the category with the higher expected return as represented in performance field 706 ((7).

The above description is illustrative only and is not limiting. Instead, the present invention is defined solely by the claims which follow and their full range of equivalents.

What is claimed is:

1. A method for embedding content into an embedded section of a network-served document having substantive content, the method comprising:
determining that one or more relevant categories of topics are related to the substantive content of the network-served document;
receiving a first request through a communications network for the relevant categories wherein the request is separate from a request for the network-served document;
for each of the relevant categories, sending data representing the relevant category and one or more topics of the relevant category through the communications network for display in the embedded section;
receiving a second request through the communications network for additional information related to a selected one of the topics of a selected one of the categories of topics; and
sending data representing the additional information through the communications network in response to the request for display in the embedded section.

2. The method of claim 1 wherein determining comprises:
(a) identifying one or more keywords in the substantive content of the network-served page wherein the keywords represent one or more included ones of the topics; and
(b) determining that the included topics belong to relevant categories.

3. The method of claim 2 wherein the included topics belong to one or more included ones of the categories and wherein (b) determining comprises:
selecting the relevant categories from the included categories.

4. The method of claim 3 wherein selecting comprises:
selecting the relevant categories according to the number of times each of the included topics of each of the included categories is included in the network-served document.

5. The method of claim 3 wherein selecting comprises:
selecting the relevant categories according to respective performance measurements of each of the included categories.

6. The method of claim 1 wherein receiving the first request comprises:
receiving the first request from a host computer which stores the network-served document and sends the network-served document to client computer systems that request the network-served document.

7. The method of claim 1 wherein receiving the first request comprises:
receiving the first request for the relevant categories from a client computer which requests and receives the network-served document from a host computer system.

8. The method of claim 1 wherein sending data representing the relevant category and one or more topics of the relevant category comprises:
selecting the topics from a superset of topics of the relevant category

9. The method of claim 8 wherein selecting comprises:
selecting the topics according to the number of times each of the topics is included in the network-served document.

10. The method of claim 8 wherein selecting comprises:
selecting the topics according to respective performance measurements of each of the topics.

11. The method of claim 8 wherein selecting comprises:
selecting the topics in a randomized manner.

12. The method of claim 1 wherein wherein the network-served document is a web page.

13. A computer readable medium useful in association with a computer which includes a processor and a memory, the computer readable medium including computer instructions which are configured to cause the computer to embed content into an embedded section of a network-served document having substantive content by:
determining that one or more relevant categories of topics are related to the substantive content of the network-served document;
receiving a first request through a communications network for the relevant categories wherein the request is separate from a request for the network-served document;
for each of the relevant categories, sending data representing the relevant category and one or more topics of the relevant category through the communications network for display in the embedded section;
receiving a second request through the communications network for additional information related to a selected one of the topics of a selected one of the categories of topics; and
sending data representing the additional information through the communications network in response to the request for display in the embedded section.

14. The computer readable medium of claim 13 wherein determining comprises:
(a) identifying one or more keywords in the substantive content of the network-served page wherein the keywords represent one or more included ones of the topics; and
(b) determining that the included topics belong to relevant categories.

15. The computer readable medium of claim 14 wherein the included topics belong to one or more included ones of the categories and wherein (b) determining comprises:
selecting the relevant categories from the included categories.

16. The computer readable medium of claim 15 wherein selecting comprises:
selecting the relevant categories according to the number of times each of the included topics of each of the included categories is included in the network-served document.

17. The computer readable medium of claim 15 wherein selecting comprises:
selecting the relevant categories according to respective performance measurements of each of the included categories.

18. The computer readable medium of claim 13 wherein receiving the first request comprises:
receiving the first request from a host computer which stores the network-served document and sends the network-served document to client computer systems that request the network-served document.

19. The computer readable medium of claim 13 wherein receiving the first request comprises:
receiving the first request for the relevant categories from a client computer which requests and receives the network-served document from a host computer system.

20. The computer readable medium of claim 13 wherein sending data representing the relevant category and one or more topics of the relevant category comprises:
selecting the topics from a superset of topics of the relevant category

21. The computer readable medium of claim 20 wherein selecting comprises:
selecting the topics according to the number of times each of the topics is included in the network-served document.

22. The computer readable medium of claim 20 wherein selecting comprises:
selecting the topics according to respective performance measurements of each of the topics.

23. The computer readable medium of claim 20 wherein selecting comprises:
selecting the topics in a randomized manner.

24. The computer readable medium of claim 13 wherein wherein the network-served document is a web page.

25. A computer system comprising:
a processor;
a memory operatively coupled to the processor; and
an adjunct information serving module (i) which executes in the processor from the memory and (ii) which, when executed by the processor, causes the computer to embed content into an embedded section of a network-served document having substantive content by:
determining that one or more relevant categories of topics are related to the substantive content of the network-served document;
receiving a first request through a communications network for the relevant categories wherein the request is separate from a request for the network-served document;
for each of the relevant categories, sending data representing the relevant category and one or more topics of the relevant category through the communications network for display in the embedded section;
receiving a second request through the communications network for additional information related to a selected one of the topics of a selected one of the categories of topics; and
sending data representing the additional information through the communications network in response to the request for display in the embedded section.

26. The computer system of claim 25 wherein determining comprises:
(a) identifying one or more keywords in the substantive content of the network-served page wherein the keywords represent one or more included ones of the topics; and
(b) determining that the included topics belong to relevant categories.

27. The computer system of claim 26 wherein the included topics belong to one or more included ones of the categories and wherein (b) determining comprises:
selecting the relevant categories from the included categories.

28. The computer system of claim 27 wherein selecting comprises:
selecting the relevant categories according to the number of times each of the included topics of each of the included categories is included in the network-served document.

29. The computer system of claim 27 wherein selecting comprises:
selecting the relevant categories according to respective performance measurements of each of the included categories.

30. The computer system of claim 25 wherein receiving the first request comprises:
receiving the first request from a host computer which stores the network-served document and sends the network-served document to client computer systems that request the network-served document.

31. The computer system of claim 25 wherein receiving the first request comprises:
receiving the first request for the relevant categories from a client computer which requests and receives the network-served document from a host computer system.

32. The computer system of claim 28 wherein sending data representing the relevant category and one or more topics of the relevant category comprises:
selecting the topics from a superset of topics of the relevant category

33. The computer system of claim 32 wherein selecting comprises:
selecting the topics according to the number of times each of the topics is included in the network-served document.

34. The computer system of claim 32 wherein selecting comprises:
selecting the topics according to respective performance measurements of each of the topics.

35. The computer system of claim 32 wherein selecting comprises:
selecting the topics in a randomized manner.

36. The computer system of claim 25 wherein wherein the network-served document is a web page.
